(19) United States
(12) Patent Application Publication
(10) Pub. No.: US 2026/0110258 A1
(43) Pub. Date: Apr. 23, 2026

(54) CATALYST PREHEATING SYSTEM

(71) Applicant: FCA US LLC, Auburn Hills, MI (US)

(72) Inventors: Jeff Brand, Auburn Hills, MI (US); Ryan M. Sturgeon, Auburn Hills, MI (US); Brett M. Schubring, Auburn Hills, MI (US); Greg Beverly, Auburn Hills, MI (US)

(21) Appl. No.: 18/922,712

(22) Filed: Oct. 22, 2024

(51) Int. Cl. F01N 3/20; B01D 53/94; F01N 3/28

(52) U.S. Cl. CPC F01N 3/2013; B01D 53/9454; B01D 53/9495; F01N 3/2892; B01D 2257/404; B01D 2257/502; B01D 2257/702; B01D 2258/01

(57) ABSTRACT

An internal combustion engine system includes an internal combustion engine, a main exhaust aftertreatment system with a main catalytic converter, and a catalyst preheating system with a recirculation passage, a pump, and a heating element configured to selectively receive exhaust gas from the internal combustion engine. A controller is configured to determine a cold start, long idle, and/or low main catalytic converter temperature condition, activate the pump to draw the exhaust gas through the recirculation passage and the heating element, and create a looped flow of exhaust gas that facilitates minimizing exhaust gas flow and thermal energy loss through a tailpipe of the main exhaust aftertreatment system, and activate the heating element to rapidly heat the looped flow of exhaust gas.

### FIELD

The present application relates generally to internal combustion engine aftertreatment systems and, more particularly, to an internal combustion engine having a heated catalyst recirculation system.

### BACKGROUND

In conventional internal combustion aftertreatment systems it is difficult to achieve low tailpipe emissions in the time immediately following a cold engine start due to low catalyst conversion efficiency of cold catalysts. In order to achieve acceptable conversion efficiency, the catalyst must surpass a predetermined light-off temperature. In some systems, faster light-off temperatures may be achieved, but often at the cost of high exhaust system backpressure, durability, longevity, cost, and/or complexity. Thus, while such conventional systems do work well for their intended purpose, it is desirable to provide continuous improvement in the relevant art.

### SUMMARY

In accordance with one example aspect of the invention, an internal combustion engine system is provided. In one example implementation, the engine system includes an internal combustion engine, a main exhaust aftertreatment system with a main catalytic converter configured to receive exhaust gas from the internal combustion engine, and a catalyst preheating system with a recirculation passage, a pump, and a heating element configured to selectively receive exhaust gas from the internal combustion engine. A controller includes one or more processors and a non-transitory computer-readable storage medium having a plurality of instructions stored thereon, which, when executed by the one or more processors, cause the one or more processors to perform operations comprising: determine a cold start, long idle, and/or low main catalytic converter temperature condition; activate the pump to draw the exhaust gas through the recirculation passage and the heating element, and create a looped flow of exhaust gas that facilitates minimizing exhaust gas flow and thermal energy loss through a tailpipe of the main exhaust aftertreatment system; and activate the heating element to rapidly heat the looped flow of exhaust gas.

In addition to the foregoing, the described engine system may include one or more of the following features: an exhaust manifold configured to supply exhaust gas through a main outlet duct, and to the main exhaust aftertreatment system and the main catalytic converter, wherein the recirculation passage is in fluid communication with main outlet duct; a valve configured to move between a first position that enables exhaust gas to flow through the recirculation passage, and a second position that prevents exhaust gas flow through the recirculation passage; wherein the valve is a first valve and a second valve; wherein valve is located within the recirculation passage; and wherein the valve is located within the main outlet duct.

In addition to the foregoing, the described engine system may include one or more of the following features: wherein the heating element is located within the recirculation passage; wherein the heating element is located within the main outlet duct; a secondary catalytic converter located within the recirculation passage; a secondary catalytic converter located within the main outlet duct; wherein the main catalytic converter is located within the main outlet duct and receives the looped flow of exhaust gas; and wherein the pump is located within the recirculation passage.

In addition to the foregoing, the described engine system may include one or more of the following features: a secondary catalytic converter disposed within the recirculation passage, wherein the pump is located downstream of the heating element and the secondary catalytic converter; a secondary catalytic converter disposed within the recirculation passage, wherein the pump is located upstream of the heating element and the secondary catalytic converter; a secondary catalytic converter disposed within the recirculation passage, wherein the pump is located upstream of the heating element and the secondary catalytic converter; and wherein the controller is further configured to perform operations including determine the main catalytic converter has reached a predetermined light-off temperature, and subsequently turn off the pump and the heating element.

In accordance with another example aspect of the invention, a method of operating an internal combustion engine system is provided. In one example implementation, the engine system includes an internal combustion engine, a main exhaust aftertreatment system with a main catalytic converter configured to receive exhaust gas from the internal combustion engine, and a catalyst preheating system with a recirculation passage, a pump, and a heating element configured to selectively receive exhaust gas from the internal combustion engine.

In one example implementation, the method includes monitoring, by a controller having one or more processors, a temperature of the main catalytic converter to determine if the temperature is below a predetermined light-off temperature; activating, by the controller, the pump to draw the exhaust gas through the recirculation passage and the heating element, and create a looped flow of exhaust gas that facilitates minimizing exhaust gas flow and thermal energy loss through a tailpipe of the main exhaust aftertreatment system; and activating, by the controller, the heating element to rapidly heat the looped flow of exhaust gas.

In addition to the foregoing, the described method may include one or more of the following features: wherein the internal combustion engine system further includes a valve configured to move between a first position that enables exhaust gas to flow through the recirculation passage, and a second position that prevents exhaust gas flow through the recirculation passage; wherein the valve is a first valve and a second valve; and wherein the first and second valves are located at opposite ends of the recirculation passage.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic diagram of an example catalyst preheating system in accordance with the principles of the present application;

FIG. 2 is a schematic diagram of another example catalyst preheating system in accordance with the principles of the present application;

FIG. 3 is a schematic diagram of yet another example catalyst preheating system in accordance with the principles of the present application;

FIG. 4 is a schematic diagram of yet another example catalyst preheating system in accordance with the principles of the present application; and

FIG. 5 is a flow control diagram of an example method of operating the catalyst preheating system of FIGS. 1-4, in accordance with the principles of the present application.

### DESCRIPTION

As previously described, some conventional aftertreatment systems have limited or no capacity to get the catalyst to a light-off temperature for efficient conversion of harmful exhaust constituents before approximately fifteen seconds post cold start in a turbocharged system. Every second the engine is running and the catalyst is not at or above light-off temperature, CO, HC, and NOx are not being converted efficiently. The short time preceding the catalyst light-off is responsible for a very large portion of the CO, HC, and NOx breakthrough for on and off cycle starts and long idles. In conventional systems, one or more catalysts are traditionally located some distance downstream of the exhaust outlet of the cylinder head and/or turbocharger outlet and are typically in the main exhaust flow for the entire useful life of the vehicle.

Accordingly, described herein are systems and methods for a catalyst preheating system that utilizes an electrically heated element and a pump to recirculate exhaust gas through a loop or recirculation passage to rapidly warm a catalyst. During a cold start, long idle, restart, and/or low main catalyst temperatures, the heating element is activated and the pump recirculates exhaust gas through the passage to avoid energy loss out the tailpipe. This allows for rapid catalyst light-off and improved conversion of harmful exhaust constituents.

In one example, the system described herein is configured to improve tailpipe emissions, particularly for cold starts and restarts, of an internal combustion engine in conventional vehicles and even range extended electric vehicles (REEVs), plug-in hybrid electric vehicles (PHEVs), and hybrid electric vehicles (HEVs). The system utilizes an electrically heated element, such as an electrically heated catalyst (EHC), and one or more pumps, catalysts, and valves with an alternative exhaust path to force air/exhaust flow to move in a recirculating loop instead of immediately exiting the exhaust system. Sensors, such as wide range O2 sensors, switching O2 sensors, NOx sensors and thermocouples may be used in varying locations and quantities for control of the system.

Prior to or during an engine start event, the pump(s) force air/exhaust gases currently in the exhaust pipe to flow in a loop that contains the heating element, catalyst(s), and valve(s). The gases heated by the heating element will loop back through the system instead of exiting out of the tailpipe, which allows for more rapid and efficient catalyst heating and light-off, thereby yielding improved conversion efficiencies faster. The system is configured to reduce energy demands of the heating element and reduce pre-heating times while enabling the system to efficiently maintain catalyst temperatures in hybrid vehicles that commonly have long engine-off times.

As such, the system generally includes a loop flow system to recirculate exhaust gases during cold catalyst scenarios. The recirculation passage may include various tubes, bellows, elbows, valves (e.g., wastegate type, butterfly type, etc.), actuators to control the valves, pump(s) (e.g., positive displacement, centrifugal, axial-flow, etc.), heating elements (e.g., EHC) to add thermal energy to the fluid, catalyst(s) to accept the thermal energy, and sensors (e.g., temperature, O2, NOx, current, voltage, etc.) to control the system. The described components may be arranged in various locations and sequences, as described herein in more detail.

In hybrid applications, the engine may not start for some time after the vehicle starts moving and can also have subsequent engine restarts. Large emissions challenges can arise in scenarios where the catalysts are not warm when the engine needs to start. These restarts and cold starts have a fuel, battery energy, and emissions cost in addition to negative range and MPG impacts. Further, it may be challenging to get low tailpipe emissions (high catalyst conversion efficiency) in the time immediately following engine starts without large compromises. This issue is especially prevalent in hybridized applications that can have engine starts (cold or warm) while the vehicle is in motion because the engine often needs to prioritize driver demand, which can increase engine-out emissions.

Accordingly, the systems described herein provide a recirculated and heated exhaust flow that allows for zero or nearly zero energy losses out of the tailpipe during initial heat up and subsequent reheating/maintenance. The recirculated aspect allows for increased efficiency over a conventional system by recycling the already heated flow back through the EHC loop, eliminating flow out of the tailpipe.

The systems advantageously allow for less extreme calibration strategies for generating more heat in the exhaust gas, which can improve NHV, decrease fuel consumption, and increase emissions robustness. Additionally, the increased efficiency may allow for lower power EHCs, increased robustness to high powered cold starts (HPCS), faster warmup, lower battery/fuel energy needs, and therefor increased range and fuel economy. Some of the loop design iterations place the EHC and/or catalyst in the recirculation loop, which can allow for hot end and cold end opportunities for lower system backpressure and possible platinum group metals (PGM) reduction on the main catalyst(s).

The catalyst located in the loop could have high precious metal loading with high cell density substrate so that it has very high conversion efficiency at cold start. The high cell density substrate could cause significant exhaust backpressure in a conventional system. Neither the backpressure nor aging are concerns for the loop catalyst since it can be bypassed outside of cold start and low temperature conditions. The main catalyst in this scenario could use less precious metal since it is not relied upon for cold start emissions. Precious metal loading of the main (and much larger) catalyst makes up a significant cost of the emissions system and is also responsible for aging or performance degradation of the emissions system during its full useful life.

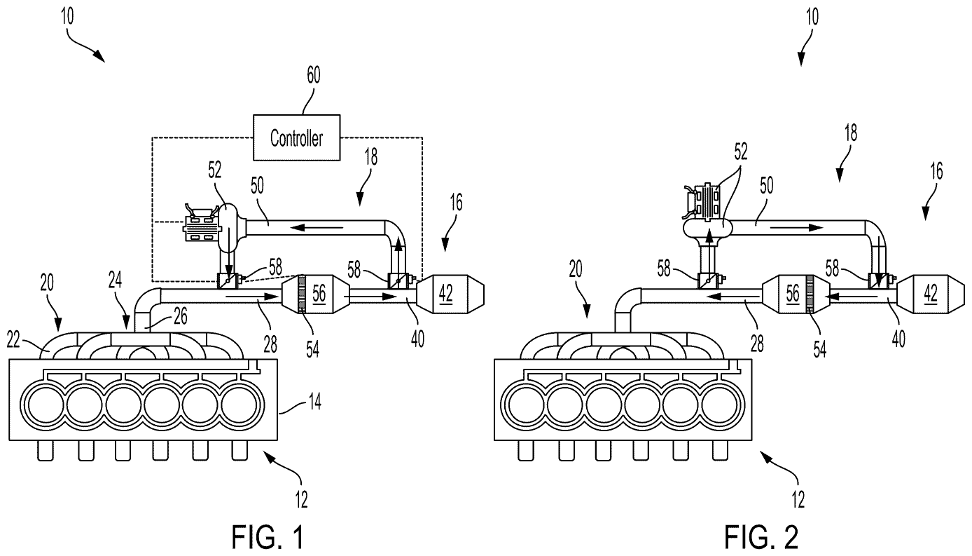

With initial reference to FIG. 1, an internal combustion engine system 10 having an internal combustion engine 12 with a cylinder head 14 is illustrated in accordance with the principles of the present application. In the example embodiment, the cylinder head 14 is configured to selectively supply exhaust gas to a main exhaust aftertreatment system 16 and a catalyst preheating system 18. As described herein in more detail, the catalyst preheating system 18 is selectively utilized during cold start, long idle, and/or cold catalyst conditions to rapidly heat to light-off temperatures to quickly achieve low tailpipe emissions.

As shown in FIG. 1, the engine system 10 further includes an exhaust manifold 20 having a plurality of cylinder exhaust passages 22 that merge together to form a collector portion or main exhaust passage 24 having an outlet 26. In some embodiments, the exhaust manifold 20 may be coupled (e.g., bolted) to the cylinder head 14 or alternatively integrated therein. A main outlet duct 28 receives exhaust gas from the manifold outlet 26 and is configured to direct the exhaust gas to the main exhaust aftertreatment system 16 during normal operation.

In the example embodiment, the main exhaust aftertreatment system 16 generally includes a main exhaust conduit 40 having one or more main catalytic converters 42 to reduce or convert a desired exhaust gas constituent such as, for example, carbon monoxide (CO), hydrocarbon (HC), and/or nitrogen oxides (NOx). The main exhaust conduit 40 is fluidly coupled to the main outlet duct 28 and is configured to receive exhaust gas from the vehicle engine 12 and supply the exhaust gas to the main catalytic converter 42. In order to efficiently reduce or convert CO, HC, and NOx, the main catalytic converter 42 must reach a predetermined light-off temperature. However, during some vehicle operations such as cold starts, the main catalytic converter 42 is below light-off temperature and therefore has a low catalyst conversion efficiency.

In order efficiently reduce or convert the unwanted exhaust gas constituents while the main catalytic converter 42 is below the light-off temperature, the vehicle utilizes the catalyst preheating system 18, which generally includes a loop or recirculation passage 50, one or more pumps 52, a heating element 54 (e.g., EHC), an auxiliary or secondary catalyst 56, and optionally one or more valves 58. The catalyst preheating system 18 is configured to redirect or recirculate the exhaust gas from the exhaust manifold 20, into the recirculation passage 50, and through the EHC 54 and auxiliary catalyst 56. In some embodiments, the auxiliary catalyst 56 may not be present and/or may be replaced by the main catalytic converter 42.

Because the auxiliary catalyst 56 is located close to the cylinder head 14, it is in close proximity to the engine combustion chambers and receives the exhaust gas quicker and at a higher temperature than the main catalytic converter 42 would. Moreover, the exhaust gas is heated by the EHC 54 and remains in a loop through recirculation passage 50 to keep thermal energy within the system. Thus, the auxiliary catalyst 56 is rapidly heated to its predetermined light-off temperature to achieve high catalyst conversion efficiency before the main catalytic converter 42 alone.

A controller 60 (e.g., engine control unit) is in signal communication with the pump 52, EHC 54, and valves 58. The controller 60 is configured to move the valves 58 to any position between a fully open first position and a fully closed second position. In the first position, the valves 58 enable exhaust gas to flow through the recirculation passage 50 and thus the EHC 54 and auxiliary catalyst 56. In the second position, the valves 58 prevent exhaust gas from flowing through the recirculation passage 50, EHC 54, and auxiliary catalyst 56. Although illustrated in the example implementation as a butterfly valve, it will be appreciated that valve 58 may be any suitable valve that enables catalyst preheating system 18 to operate as described herein.

In one example, the auxiliary catalyst 56 is a three-way catalyst configured to remove CO, HC, and NOx from the exhaust gas passing therethrough, as described herein in more detail. However, it will be appreciated that auxiliary catalyst 56 may be any suitable catalyst that enables catalyst preheating system 18 to remove any desired pollutant or compound such as, for example, a hydrocarbon trap or a four-way catalyst. In another example, auxiliary catalyst 56 has a cell density of between approximately 800 and approximately 1200 cells per square inch, or between 800 and 1200 cells per square inch.

In the example embodiment, the catalyst preheating system 18 is configured to selectively operate in (i) a normal or warm catalyst mode and (ii) a cold catalyst mode. In the warm catalyst mode, controller 60 determines the main catalytic converter 42 has reached the predetermined light-off temperature (e.g., via temperature sensor, modeled, etc.) and moves the valves 58 to the fully closed position. In this mode, the valves 58 facilitate preventing the exhaust gas in the exhaust manifold 20 from entering the recirculation passage 50 and thus EHC 54 and auxiliary catalyst 56. Instead, the exhaust gas is directed through main exhaust passage 24, into the main exhaust conduit 40, and through the main catalytic converter 42 before being exhausted to the atmosphere.

In the cold catalyst mode, controller 60 determines the main catalytic converter 42 is below the predetermined light-off temperature (e.g., a cold start), and subsequently moves the valves 58 to the fully open position and activates the pump 52 and EHC 54. In this mode, low pressure generated on the upstream side of the pump 52 draws exhaust gas into the recirculation passage 50 and through the EHC 54 and auxiliary catalyst 56, which may be combined (as shown) or separate. High pressure exhaust exiting the pump 52 returns to the low pressure side, thereby creating a recirculating clockwise flow of exhaust gas, as shown by the arrows in FIG. 1. In this way, the auxiliary catalyst 56 and exhaust gases are rapidly heated by the EHC 54 to achieve a predetermined light-off temperature before the system 18 is returned to a normal flow through the main catalyst 42 by closing valves 58. In another arrangement, only a single valve 58 is present.

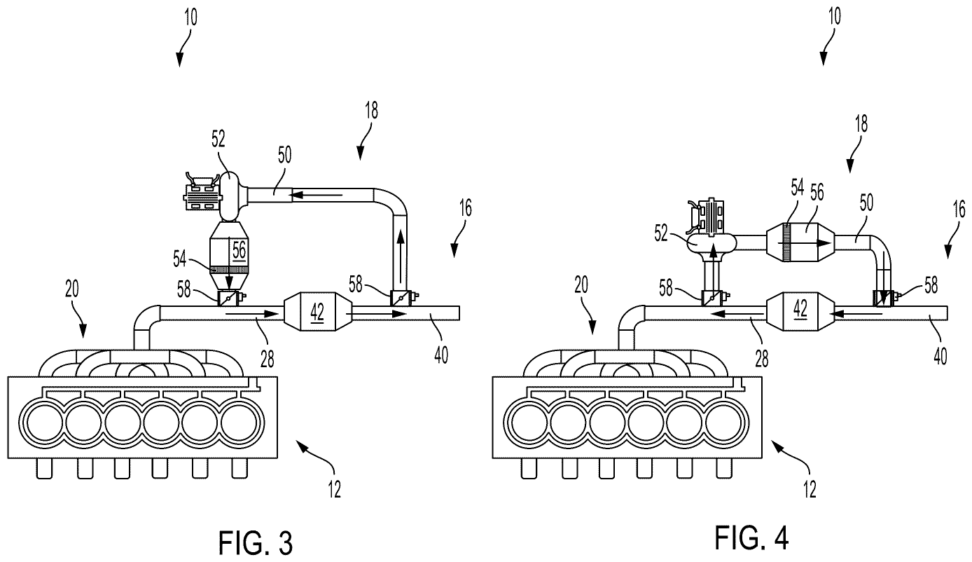

FIG. 2 illustrates an alternative arrangement where the pump 52 creates a clockwise loop flow through the recirculation passage 50. Operation is substantially similar to that in FIG. 1. FIG. 3 illustrates an alternative arrangement where the EHC 54 and auxiliary catalyst 56 are located in the recirculation passage 50 and the main catalyst 42 is located within the recirculating flow within main outlet duct 28. In another arrangement, only a single valve 58 is present. Additionally, the pump 52 may be located to provide recirculation flow in the reverse direction. In such a case, the EHC 54 is located on the upstream side of the auxiliary catalyst 56. FIG. 4 illustrates an alternative arrangement where the pump 52 is located upstream of the EHC 54 and auxiliary catalyst 56. Additionally, the pump 52 may be arranged to provide recirculation flow in the reverse direction, with the EHC 54 located on the upstream side of the auxiliary catalyst 56. It will be appreciated that pump 52, EHC 54, auxiliary catalyst 56, and valve(s) 58 may be located in any suitable location, such as within main outlet duct 28, that enables catalyst preheating system 18 to function as described herein.

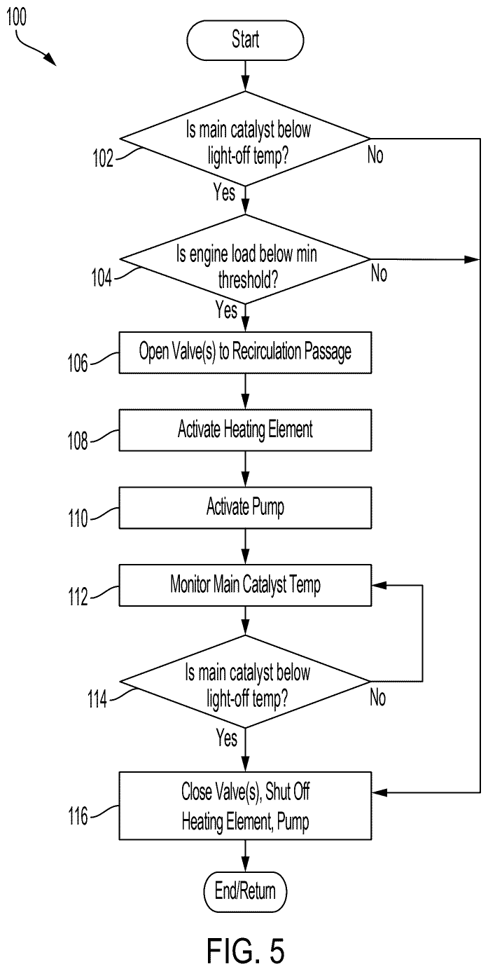

With reference now to FIG. 5, a flow diagram of an example method 100 of operating the engine system 10 is illustrated. At step 102, controller 60 (“control”) determines if the main catalyst 42 is below a predetermined light-off temperature. If no, control proceeds to step 116. If yes, control proceeds to step 104 and determines if an engine load is below a minimum threshold (e.g., a load/flow the recirculation passage 50 can handle). If no, control proceeds to step 116. If yes, control proceeds to step 106 and opens the valve(s) 58 to allow exhaust flow through the recirculation passage 50.

At step 108, control activates the EHC 54 to heat exhaust gas passing therethrough. At step 110, control activates pump 52 to draw exhaust gas into the recirculation passage 50. At step 112, control monitors the temperature of the main catalyst 42, auxiliary catalyst 56, and/or exhaust gas flowing through the recirculation loop 50. At step 114, control determines if the main catalyst 42, auxiliary catalyst 56, and/or exhaust gas flowing through the recirculation loop 50 have reached the predetermined light-off temperature of the main catalyst 42 and/or the auxiliary catalyst 56. If no, control returns to step 112. If yes, control proceeds to step 116 and returns the exhaust aftertreatment system 16 to a normal operation by closing valve(s) 58 and shutting off the pump 52 and EHC 54. Control then ends or returns to step 102.

Described herein are systems and methods for improving vehicle emissions systems efficiency, particularly during cold start, long idle, and low main catalyst temperature conditions. The system includes a catalyst preheating system with a recirculation passage to receive exhaust flow during light-off (start-up), extended idle, some low load conditions, or other conditions. To heat the exhaust to light-off temperature, valves are opened to allow flow through the recirculation passage, and a pump and EHC are activated to establish a recirculated and looping flow of exhaust gas that is heated by the EHC. In the looped flow, the heated exhaust gas is prevented from entering the main exhaust system and exiting to atmosphere to rapidly raise the temperature of the exhaust gas.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

1. An internal combustion engine system, comprising:
an internal combustion engine;
a main exhaust aftertreatment system with a main catalytic converter configured to receive exhaust gas from the internal combustion engine;
a catalyst preheating system with a recirculation passage, a pump, and an electrically heated catalyst (EHC) that includes a combined heating element and auxiliary catalyst, the EHC configured to selectively receive exhaust gas from the internal combustion engine, and wherein the auxiliary catalyst is a three-way catalyst (TWC); and
a controller having one or more processors and a non-transitory computer-readable storage medium having a plurality of instructions stored thereon, which, when executed by the one or more processors, cause the one or more processors to perform operations comprising:
determine a cold start, long idle, and/or low main catalytic converter temperature condition;
activate the pump to draw the exhaust gas through the recirculation passage and the EHC, and create a looped flow of exhaust gas that facilitates minimizing exhaust gas flow and thermal energy loss through a tailpipe of the main exhaust aftertreatment system; and
activate the heating element to rapidly heat the looped flow of exhaust gas.

2. The internal combustion engine system of claim 1, further comprising an exhaust manifold configured to supply exhaust gas through a main outlet duct, and to the main exhaust aftertreatment system and the main catalytic converter,
wherein the recirculation passage is in fluid communication with main outlet duct.

3. The internal combustion engine system of claim 2, further comprising a valve configured to move between a first position that enables exhaust gas to flow through the recirculation passage, and a second position that prevents exhaust gas flow through the recirculation passage.

4. The internal combustion engine system of claim 3, wherein the valve is a first valve and a second valve.

5. The internal combustion engine system of claim 3, wherein valve is located within the recirculation passage.

6. The internal combustion engine system of claim 3, wherein the valve is located within the main outlet duct.

7. The internal combustion engine system of claim 1, wherein the heating element is located within the recirculation passage.

8. The internal combustion engine system of claim 2, wherein the EHC is located within the main outlet duct.

9. The internal combustion engine system of claim 1, further comprising a secondary catalytic converter located within the recirculation passage.

10. The internal combustion engine system of claim 2, further comprising a secondary catalytic converter located within the main outlet duct.

11. The internal combustion engine system of claim 2, wherein the main catalytic converter is located within the main outlet duct and receives the looped flow of exhaust gas.

12. The internal combustion engine system of claim 1, wherein the pump is located within the recirculation passage.

13. The internal combustion engine system of claim 12, further comprising a secondary catalytic converter disposed within the recirculation passage,
wherein the pump is located downstream of the heating element and the secondary catalytic converter.

14. The internal combustion engine system of claim 12, further comprising a secondary catalytic converter disposed within the recirculation passage,
wherein the pump is located upstream of the heating element and the secondary catalytic converter.

15. The internal combustion engine system of claim 12, further comprising a secondary catalytic converter disposed within a main outlet duct,
wherein the pump is located upstream of the heating element and the secondary catalytic converter.

16. The internal combustion engine system of claim 1, wherein the controller is further configured to perform operations comprising:
determine the main catalytic converter has reached a predetermined light-off temperature; and
subsequently turn off the pump and the heating element.

17. A method of operating an internal combustion engine system that comprises:
an internal combustion engine;
a main exhaust aftertreatment system with a main catalytic converter configured to receive exhaust gas from the internal combustion engine; and
a catalyst preheating system with a recirculation passage, a pump, and a heating element configured to selectively receive exhaust gas from the internal combustion engine, the method comprising:
monitoring, by a controller having one or more processors, a temperature of the main catalytic converter to determine if the temperature is below a predetermined light-off temperature;
activating, by the controller, the pump to draw the exhaust gas through the recirculation passage and the heating element, and create a looped flow of exhaust gas that facilitates minimizing exhaust gas flow and thermal energy loss through a tailpipe of the main exhaust aftertreatment system; and
activating, by the controller, the heating element to rapidly heat the looped flow of exhaust gas.

18. The method of claim 17, wherein the internal combustion engine system further includes a valve configured to move between a first position that enables exhaust gas to flow through the recirculation passage, and a second position that prevents exhaust gas flow through the recirculation passage.

19. The method of claim 18, wherein the valve is a first valve and a second valve.

20. The method of claim 19, wherein the first and second valves are located at opposite ends of the recirculation passage.
